(19) United States
(12) Patent Application Publication
(10) Pub. No.: US 2024/0429585 A1
(43) Pub. Date: Dec. 26, 2024

(54) TRANSMISSION LINE, ANTENNA, AND DISPLAY DEVICE

(71) Applicant: TDK Corporation, Tokyo (JP)

(72) Inventor: Kenichi TEZUKA, Tokyo (JP)

(73) Assignee: TDK Corporation, Tokyo (JP)

(21) Appl. No.: 18/826,240

(22) Filed: Sep. 6, 2024

Related U.S. Application Data
(63) Continuation of application No. PCT/JP2023/008910, filed on Mar. 8, 2023.

(30) Foreign Application Priority Data
Mar. 10, 2022 (JP) 2022-036867

(51) Int. Cl. H01P 3/02; H01Q 9/04

(52) U.S. Cl. CPC H01P 3/02; H01Q 9/0407

(57) ABSTRACT

A transmission line includes a line portion extending in a first direction on one main surface side of a dielectric, and a terminal portion connected to an end part of the line portion, in which the line portion includes an opening conductor portion having a conductor pattern including an opening, and a planar conductor portion configured to be electrically connected to the opening conductor portion and to have a conductor extending so as to form a planar surface, the planar conductor portion is disposed apart from the terminal portion in the first direction, and the planar conductor portion has a length in the first direction greater than or equal to a length of the planar conductor portion in a second direction orthogonal to the first direction.

### CROSS-REFERENCE TO RELATED APPLICATIONS

This application is a continuation application of PCT Application No. PCT/JP2023/008910, filed on Mar. 8, 2023, which claims the benefit of priority from Japanese Patent Application No. 2022-036867, filed on Mar. 10, 2022. The entire contents of the above listed PCT and priority applications are incorporated herein by reference.

### TECHNICAL FIELD

The present disclosure relates to a transmission line, an antenna, and a display device.

### BACKGROUND

Conventionally, an antenna is known which includes a radiation electrode, a transmission line, and a pad electrode (for example, Patent Literature 1: Japanese Unexamined Patent Publication No. 2021-518071). In the antenna, the radiation electrode and the transmission line each include a mesh-like conductor pattern, and the pad electrode is configured with a solid planar conductor.

### SUMMARY

A transmission line according to one aspect of the present disclosure includes a line portion extending in a first direction on one main surface side of a dielectric, and a terminal portion connected to an end part of the line portion, in which the line portion includes an opening conductor portion having a conductor pattern including an opening, and a planar conductor portion configured to be electrically connected to the opening conductor portion and to have a conductor extending so as to form a planar surface, the planar conductor portion is disposed apart from the terminal portion in the first direction, and the planar conductor portion has a length in the first direction greater than or equal to a length of the planar conductor portion in a second direction orthogonal to the first direction.

An antenna according to an aspect of the present disclosure includes the transmission line and a radiating element portion connected to the transmission line.

A display device according to an aspect of the present disclosure includes the antenna described above.

### BRIEF DESCRIPTION OF THE DRAWINGS

FIG. 1 is a plan view illustrating an electroconductive film including an antenna according to an embodiment.

FIG. 2 is a cross-sectional view taken along the line II-II in FIG. 1.

FIG. 3 is a cross-sectional view illustrating an electroconductive film according to a modification.

FIG. 4 is a cross-sectional view illustrating a display device according to an embodiment.

FIG. 5 is a plan view of an antenna.

FIG. 6 is an enlarged view of the vicinity of a terminal portion of a transmission line.

FIGS. 7A and 7B are cross-sectional views illustrating layer structures of a planar electroconductive portion.

FIG. 8 is a diagram illustrating an equivalent circuit of a transmission line.

FIGS. 9A and 9B are diagrams illustrating transmission lines according to a modification.

FIG. 10 is a diagram illustrating a test specimen according to an example for measurement.

FIG. 11 is a diagram illustrating a test specimen according to a comparative example for measurement.

FIGS. 12A and 12B are graphs showing measurement results.

FIGS. 13A and 13B are graphs showing simulation results.

FIGS. 14A and 14B are graphs showing simulation results.

FIGS. 15A and 15B are graphs showing simulation results.

FIGS. 16A and 16B are graphs showing simulation results.

FIGS. 17A and 17B are graphs showing simulation results.

FIGS. 18A and 18B are graphs showing simulation results.

### DETAILED DESCRIPTION

Here, in a transmission line used for the antenna as described above, in a case where a line portion is configured with a mesh-like conductor pattern, frequency dependence increases due to an increase in inductance components. This poses a problem that reducing a return loss over a wide frequency range is difficult.

To address this, an object of the present disclosure is to provide a transmission line in which a return loss can be reduced over a wide frequency range, an antenna, and a display device.

According to an aspect of the present disclosure, it is possible to provide a transmission line in which a return loss can be reduced over a wide frequency range, an antenna, and a display device.

The following describes in detail several embodiments of the present disclosure. However, the present disclosure is not limited to the embodiments described below.

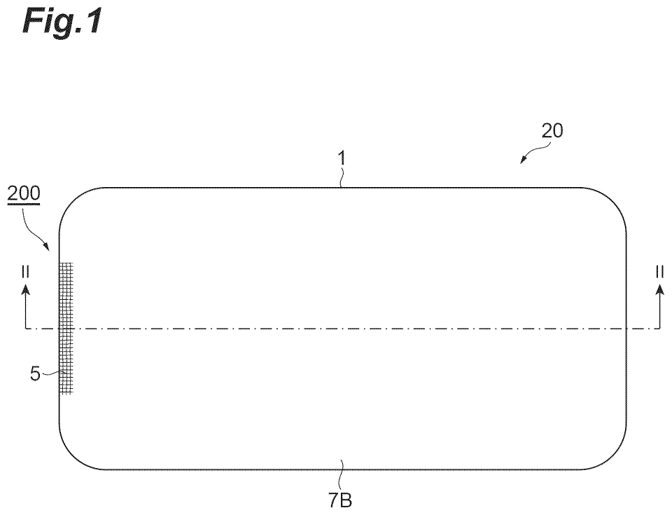

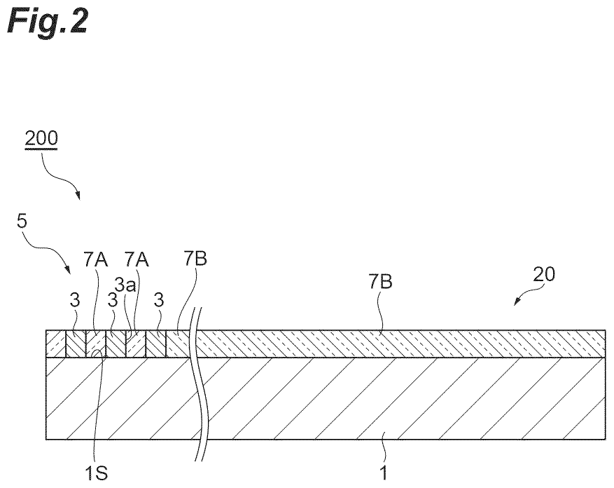

FIG. 1 is a plan view illustrating an electroconductive film including an antenna according to an embodiment of the present disclosure, and FIG. 2 is a cross-sectional view taken along the line II-II in FIG. 1. An electroconductive film 20 illustrated in FIGS. 1 and 2 includes a film-like light transmissive substrate 1 (substrate), an electroconductive layer 5 provided on one main surface 1S of the light transmissive substrate 1, and a light transmissive resin layer 7B provided on that one main surface 1S of the light transmissive substrate 1. The electroconductive layer 5 includes a conductor portion 3 that includes a part having a pattern extending in a direction along the main surface 1S of the light transmissive substrate 1 and including a plurality of openings 3a, and an insulating resin portion 7A filling the openings 3a of the conductor portion 3. In FIG. 2, the electroconductive layer 5 is illustrated in a deformed manner, and the width of the conductor portion 3 is illustrated in an emphasized manner. The thickness of each layer is also illustrated in a deformed manner. Details of the thickness of each layer will be described later. In the example illustrated in FIG. 1, the electroconductive layer 5 is formed near one short side of the electroconductive film 20, but the position where the electroconductive layer 5 is formed is not particularly limited, and the electroconductive layer 5 may be formed near a long side.

The light transmissive substrate 1 has optical transparency to an extent required when the electroconductive film 20 is incorporated in a display device. Specifically, the total light transmittance of the light transmissive substrate 1 may be 90 to 100%. The light transmissive substrate 1 may have a haze of 0 to 5%.

The light transmissive substrate 1 may be, for example, a transparent resin film, and examples thereof include a film of polyethylene terephthalate (PET), polycarbonate (PC), polyethylene naphthalate (PEN), cycloolefin polymer (COP), or polyimide (PI). Alternatively, the light transmissive substrate 1 may be a glass substrate.

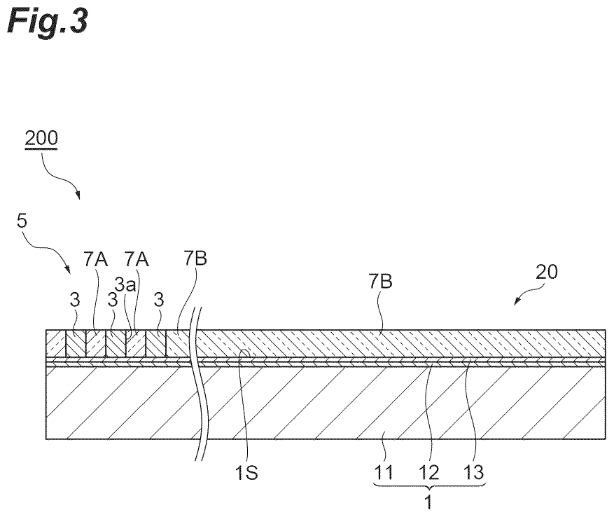

For example, as illustrated in FIG. 3, the light transmissive substrate 1 may be a laminate including a light transmissive support film 11, and an intermediate resin layer 12 and an underlying layer 13 sequentially provided on the support film 11. The support film 11 can be the transparent resin film. The underlying layer 13 is a layer provided in order to form the conductor portion 3 by electroless plating or the like. In a case where the conductor portion 3 is formed by another method, the underlying layer 13 is not necessarily provided. It is not essential that the intermediate resin layer 12 is provided between the support film 11 and the underlying layer 13.

The thickness of the light transmissive substrate 1 or the support film 11 constituting the same may be 10 μm or more, 20 μm or more, or 35 μm or more, and may be 500 μm or less, 200 μm or less, or 100 μm or less.

Adhesion between the support film 11 and the underlying layer 13 can be improved by providing the intermediate resin layer 12. In a case where the underlying layer 13 is not provided, the intermediate resin layer 12 is provided between the support film 11 and the light transmissive resin layer 7B, so that adhesion between the support film 11 and the light transmissive resin layer 7B can be improved.

The intermediate resin layer 12 may be a layer containing a resin and an inorganic filler. Examples of the resin constituting the intermediate resin layer 12 include an acrylic resin. Examples of the inorganic filler include silica.

The thickness of the intermediate resin layer 12 may be, for example, greater than or equal to 5 nm, greater than or equal to 100 nm, or greater than or equal to 200 nm, and may be less than or equal to 10 μm, less than or equal to 5 μm, or less than or equal to 2 μm.

The underlying layer 13 may be a layer containing a catalyst and a resin. The resin may be a cured product of a curable resin composition. Examples of a curable resin contained in the curable resin composition include an amino resin, a cyanate resin, an isocyanate resin, a polyimide resin, an epoxy resin, an oxetane resin, a polyester, an allyl resin, a phenolic resin, a benzoxazine resin, a xylene resin, a ketone resin, a furan resin, a COPNA resin, a silicon resin, a dicyclopentadiene resin, a benzocyclobutene resin, an episulfide resin, a thiol-ene resin, a polyazomethine resin, a polyvinyl benzyl ether compound, acenaphthylene, and an ultraviolet curable resin containing a functional group that causes a polymerization reaction with ultraviolet rays such as an unsaturated double bond, a cyclic ether, and a vinyl ether.

The catalyst contained in the underlying layer 13 may be an electroless plating catalyst. The electroless plating catalyst may be a metal selected from Pd, Cu, Ni, Co, Au, Ag, Pd, Rh, Pt, In, and Sn, or may be Pd. The catalyst may be one kind alone or a combination of two or more kinds. Usually, the catalyst is dispersed in the resin as catalyst particles.

The content of the catalyst in the underlying layer 13 may be greater than or equal to 3 mass %, greater than or equal to 4 mass %, or greater than or equal to 5 mass %, and may be less than or equal to 50 mass %, less than or equal to 40 mass %, or less than or equal to 25 mass % with respect to the total amount of the underlying layer 13.

The thickness of the underlying layer 13 may be, for example, greater than or equal to 10 nm, greater than or equal to 20 nm, or greater than or equal to 30 nm, and may be less than or equal to 500 nm, less than or equal to 300 nm, or less than or equal to 150 nm.

The light transmissive substrate 1 may further include a protective layer provided on a main surface of the support film 11 opposite to the light transmissive resin layer 7B and the conductor portion 3. Providing the protective layer prevents the support film 11 from being scratched. The protective layer can be a layer similar to the intermediate resin layer 12. The thickness of the protective layer may be, for example, greater than or equal to 5 nm, greater than or equal to 50 nm, or greater than or equal to 500 nm, and may be less than or equal to 10 μm, less than or equal to 5 μm, or less than or equal to 2 μm.

The conductor portion 3 constituting the electroconductive layer 5 includes a part having a pattern including the openings 3a. The pattern including the openings 3a is a mesh-like pattern that is formed by a plurality of linear portions intersecting each other and includes the plurality of openings 3a regularly arranged. The conductor portion 3 having the mesh-like pattern can favorably function as, for example, a radiating element, a power supply portion, and a ground portion of an antenna. Further, the conductor portion 3 may have a part corresponding to an electroconductive member such as a ground terminal and a power supply terminal. The configuration of the pattern of the conductor portion 3 in the electroconductive layer 5 will be detailed later.

The conductor portion 3 may contain metal. The conductor portion 3 may contain at least one metal selected from copper, nickel, cobalt, palladium, silver, gold, platinum, and tin, or may contain copper. The conductor portion 3 may be metal plating formed by a plating method.

The conductor portion 3 may further contain a nonmetallic element such as phosphorus within a range in which appropriate conductivity is maintained.

The conductor portion 3 may be a laminate including a plurality of layers. In addition, the conductor portion 3 may have a blackened layer as a surface layer portion on a side opposite to the light transmissive substrate 1. The blackened layer can contribute to improvement in visibility of a display device in which the electrically conductive film is incorporated.

The insulating resin portion 7A is formed of a light transmissive resin and is provided so as to fill the openings 3a of the conductor portion 3, and the insulating resin portion 7A and the conductor portion 3 usually form a flat surface.

The light transmissive resin layer 7B is formed of a light transmissive resin. The total light transmittance of the light transmissive resin layer 7B may be 90 to 100%. The light transmissive resin layer 7B may have a haze of 0 to 5%.

The difference between the light transmissive substrate 1 (or the refractive index of the support film constituting the light transmissive substrate 1) and the refractive index of the light transmissive resin layer 7B may be 0.1 or less. As a result, good visibility of a display image is more easily achieved. The refractive index (nd 25) of the light transmissive resin layer 7B may be, for example, 1.0 or more, and may be 1.7 or less, 1.6 or less, or 1.5 or less. The refractive index can be measured by a spectroscopic ellipsometer. In terms of uniformity of the optical path length, the conductor portion 3, the insulating resin portion 7A, and the light transmissive resin layer 7B may have substantially the same thickness.

The resin forming the insulating resin portion 7A and the light transmissive resin layer 7B may be a cured product of a curable resin composition (photocurable resin composition or thermosetting resin composition). The curable resin composition forming the insulating resin portion 7A and/or the light transmissive resin layer 7B includes a curable resin, and examples thereof include an acrylic resin, an amino resin, a cyanate resin, an isocyanate resin, a polyimide resin, an epoxy resin, an oxetane resin, a polyester, an allyl resin, a phenolic resin, a benzoxazine resin, a xylene resin, a ketone resin, a furan resin, a COPNA resin, a silicon resin, a dicyclopentadiene resin, a benzocyclobutene resin, an episulfide resin, a thiol-ene resin, a polyazomethine resin, a polyvinyl benzyl ether compound, acenaphthylene, and an ultraviolet curable resin containing a functional group that causes a polymerization reaction with ultraviolet rays such as an unsaturated double bond, a cyclic ether, and a vinyl ether.

The resin forming the insulating resin portion 7A and the resin forming the light transmissive resin layer 7B may be the same. Since the insulating resin portion 7A and the light transmissive resin layer 7B formed of the same resin have the same refractive index, the uniformity of the optical path length transmitted through the electroconductive film 20 can be further improved. In a case where the resin forming the insulating resin portion 7A and the resin forming the light transmissive resin layer 7B are the same, for example, the insulating resin portion 7A and the light transmissive resin layer 7B can be easily and collectively formed by forming a pattern from one curable resin layer by an imprinting method or the like.

The electroconductive film 20 can be manufactured, for example, by a method including pattern formation by the imprinting method. An example of a method for manufacturing the electroconductive film 20 includes: preparing the light transmissive substrate 1 including the support film, the intermediate resin layer, and the underlying layer containing the catalyst, the intermediate resin layer, and the underlying layer being provided on one main surface of the support film; forming the curable resin layer on the main surface 1S on the underlying layer side of the light transmissive substrate 1; forming a trench in which the underlying layer is exposed by an imprinting method using a mold having a convex portion; and forming the conductor portion 3 filling the trench by an electroless plating method in which metal plating is grown from the underlying layer. The curable resin layer is cured in a state where the mold is pushed into the curable resin layer to thereby form collectively the insulating resin portion 7A having a pattern including an opening with an inverted shape of the convex portion of the mold, and the light transmissive resin layer 7B. The method for forming the insulating resin portion 7A having the pattern including the opening is not limited to the imprinting method, and any method such as photolithography can be applied.

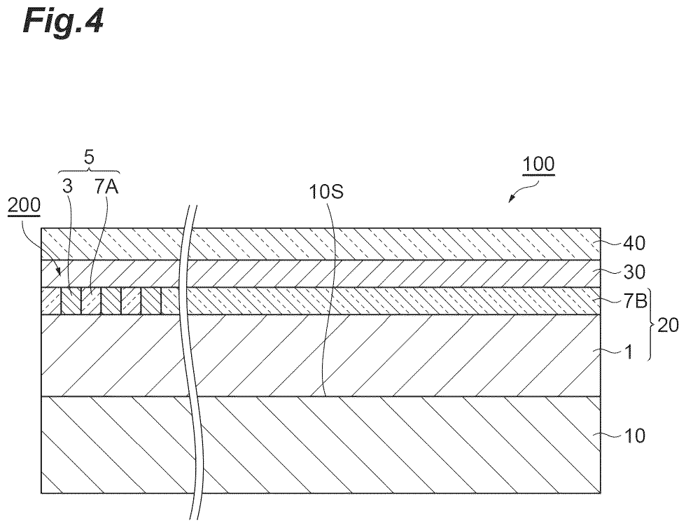

The electroconductive film described above as an example can be incorporated into a display device as the planar transparent antenna 200. The display device may be, for example, a liquid crystal display device or an organic EL display device. FIG. 4 is a cross-sectional view illustrating an embodiment of a display device in which an electroconductive film is incorporated. A display device 100 illustrated in FIG. 4 includes an image display unit 10 (display unit) having an image display region 10S, a dielectric layer 15, an electroconductive film 20 (antenna 200), a polarizing plate 30, and a cover glass 40. Here, the image display unit 10 functions as a ground conductor for the antenna 200 of the electroconductive film 20. Thus, the planar transparent antenna 200 has a patch antenna configuration. The dielectric layer 15, the electroconductive film 20, the polarizing plate 30, and the cover glass 40 are laminated, in this order from the image display unit 10 side, on the image display region 10S side of the image display unit 10. The configuration of the display device is not limited to the form of FIG. 4, and can be appropriately changed as necessary. For example, the polarizing plate 30 may be provided between the image display unit 10 and the electroconductive film 20. The image display unit 10 may be, for example, a liquid crystal display unit. As the polarizing plate 30 and the cover glass 40, those commonly used in a display device can be used.

The polarizing plate 30 and the cover glass 40 are not necessarily provided. Light for image display emitted from the image display region 10S of the image display unit 10 passes through a path having a highly uniform optical path length including the electroconductive film 20. This makes it possible to display an image with high uniformity and favorable quality with suppressed moire.

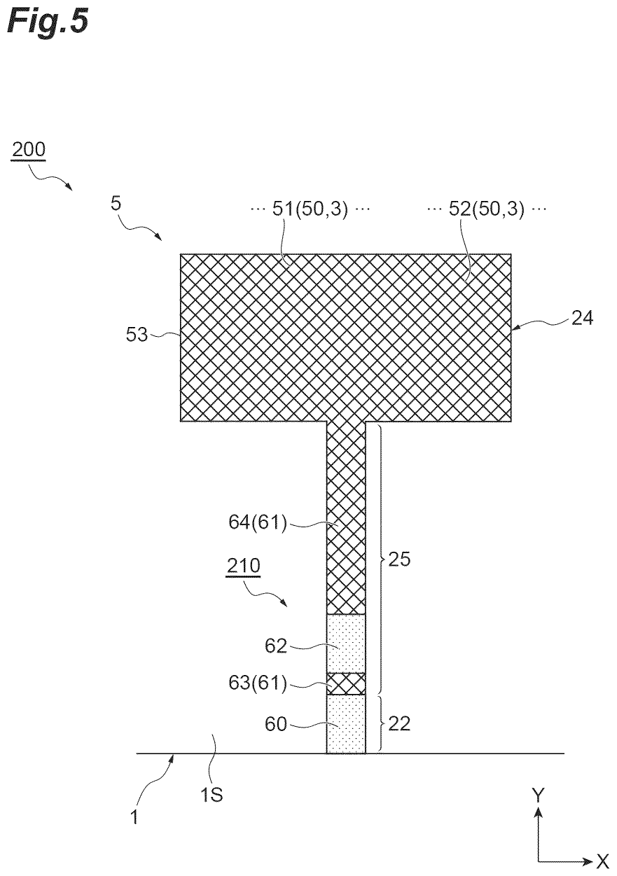

Next, a configuration of the antenna 200 and a transmission line 210 according to an embodiment of the present disclosure will be described in detail with reference to FIG. 5. The antenna 200 includes the electroconductive layer 5 described above. FIG. 5 is a plan view of the antenna 200. FIG. 5 is an enlarged view of a part of the antenna. In the following description, it is assumed that XY coordinates are set with respect to a plane parallel to the main surface 1S. The Y-axis direction (first direction) is a direction along the main surface 1S, and corresponds to a direction orthogonal to a side portion of the electroconductive film 20 in the example illustrated in FIG. 1. The center side of the electroconductive film 20 is defined as a positive side in the Y-axis direction, and the outer peripheral side of the electroconductive film 20 is defined as a negative side in the Y-axis direction. The X-axis direction (second direction) is a direction orthogonal to the Y-axis direction along the main surface 1S, and corresponds to a direction in which the side portion of the electroconductive film 20 extends in the example illustrated in FIG. 1. One side in which the side portion of the electroconductive film 20 extends is defined as a positive side in the X-axis direction, and the other side is defined as a negative side in the X-axis direction.

As illustrated in FIG. 5, the mesh pattern of the electroconductive layer 5 includes a plurality of first electroconductive lines 51 and a plurality of second electroconductive lines 52. The first electroconductive line 51 is the linear conductor portion 3 extending so as to be inclined with respect to the Y-axis direction (with respect to an end electroconductive line 53 constituting an end part). The first electroconductive line 51 extends toward the positive side in the Y-axis direction from the negative side toward the positive side in the X-axis direction. The plurality of first electroconductive lines 51 is arranged to be spaced apart from each other and parallel to each other. The plurality of first electroconductive lines 51 is arranged to be spaced apart at a constant pitch. The second electroconductive line 52 is the linear conductor portion 3 extending so as to be inclined with respect to the Y-axis direction. The second electroconductive line 52 extends toward the negative side in the Y-axis direction from the negative side toward the positive side in the X-axis direction. The plurality of second electroconductive lines 52 is arranged to be spaced apart from each other and parallel to each other. The plurality of second electroconductive lines 52 is arranged to be spaced apart at a constant pitch. In this manner, the first electroconductive lines 51 and the second electroconductive lines 52 intersect each other. In the present embodiment, the first electroconductive lines 51 and the second electroconductive lines 52 are inclined at 45° with respect to the Y-axis direction. The thickness of the electroconductive lines 51 and 52 is not particularly limited, and may be set to 1 to 3 μm. The pitch of the electroconductive lines 51 and 52 is not particularly limited, and may be set to, for example, 100 to 300 μm.

The antenna 200 includes a radiating element portion 24 and the transmission line 210. The radiating element portion 24 and a part of the transmission line 210 each have the mesh-like conductor pattern 50 described above.

The radiating element portion 24 is a region that radiates a signal as an antenna. The radiating element portion 24 has a rectangular shape having two sides parallel to the Y-axis direction and two sides parallel to the X-axis direction. Although the radiating element portion 24 having a rectangular shape is illustrated in the drawing, the shape of the radiating element portion 24 is not particularly limited, and may be a square shape, a circular shape, or a polygonal shape other than a quadrilateral.

The transmission line 210 includes a line portion 25 and a terminal portion 22. The line portion 25 extends in the Y-axis direction on the one main surface 1S side of the light transmissive substrate 1 (dielectric). The line portion 25 is a region functioning as a feed line that supplies power to the radiating element portion 24. The line portion 25 has a belt-like shape extending parallel to the Y-axis direction. The line portion 25 is connected to the side of the radiating element portion 24 on the negative side in the Y-axis direction. In the present embodiment, the radiating element portion 24 and the line portion 25 include the end electroconductive line 53 constituting an outer peripheral edge of the conductor pattern. The end electroconductive line 53 is not essential. In this case, the outer peripheral edge is defined by a virtual line connecting the ends of the electroconductive lines 51 and 52.

The terminal portion 22 is connected to an end part of the line portion 25 on the negative side in the Y-axis direction. The terminal portion 22 is connected to a connection terminal of an external device. The terminal portion 22 has a rectangular shape having two sides parallel to the Y-axis direction and two sides parallel to the X-axis direction. The terminal portion 22 is connected to the line portion 25 at a side portion of the terminal portion 22 on the positive side in the Y-axis direction. Although the terminal portion 22 having a rectangular shape is illustrated in the drawing, the shape of the terminal portion 22 is not particularly limited, and may be a square shape. The terminal portion 22 is configured with a planar conductor portion 62 in which a conductor extends so as to form a planar surface. The planar conductor portion 62 is a conductor portion formed by solidly applying an electroconductive material, and forms a plane extending in the XY direction. The entire region of the terminal portion 22 has the planar conductor portion 62.

The line portion 25 includes a mesh portion 61 and the planar conductor portion 62. The mesh portion 61 is a mesh-like region configured with the electroconductive lines 51 and 52. The mesh portion 61 has the mesh-like conductor pattern 50 described above. In the present embodiment, the mesh portion 61 constitutes an opening conductor portion having a conductor pattern including an opening. The planar conductor portion 62 is electrically connected to the mesh portion 61 and is a region where a conductor extends so as to form a planar surface. The planar conductor portion 62 is a conductor portion formed by solidly applying an electroconductive material, and forms a plane extending in the XY direction. The planar conductor portion 62 is disposed apart from the terminal portion 22 in the Y-axis direction. The planar conductor portion 62 is disposed in a region of the line portion 25 near an end part on the negative side in the Y-axis direction. In the present embodiment, the planar conductor portion 62 has a rectangular shape having two sides parallel to the Y-axis direction and two sides parallel to the X-axis direction.

The mesh portion 61 includes a first region 63 and a second region 64. The first region 63 is a region disposed between the terminal portion 22 and the planar conductor portion 62 in the Y-axis direction. The first region 63 has a rectangular shape having two sides parallel to the Y-axis direction and two sides parallel to the X-axis direction. The second region 64 is a region sandwiching the planar conductor portion 62 with the first region 63 in the Y-axis direction. The second region 64 is disposed between the planar conductor portion 62 and the radiating element portion 24 in the Y-axis direction. In other words, in the present embodiment, the mesh portion 61 and the planar conductor portion 62 are connected in the Y-axis direction. The second region 64 is disposed in the entire region of the line portion 25 on the positive side in the Y-axis direction with respect to the planar conductor portion 62. The second region 64 has a rectangular shape having two sides parallel to the Y-axis direction and two sides parallel to the X-axis direction. The second region 64 has an elongated rectangular shape whose longitudinal direction is the Y-axis direction.

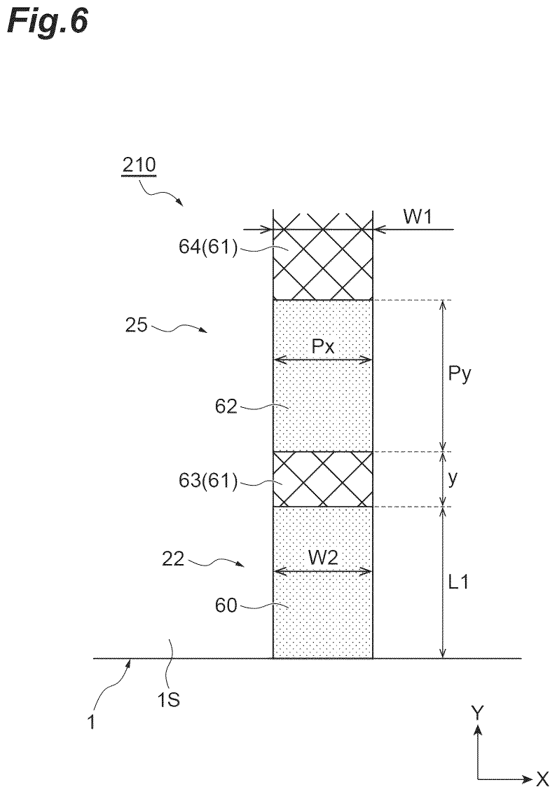

Next, a dimensional relationship of the transmission line 210 will be described with reference to FIG. 6. FIG. 6 is an enlarged view of the vicinity of the terminal portion 22 of the transmission line 210. The length W1 of the mesh portion 61 in the X-axis direction may be set to 100 to 400 μm. The length W2 of a terminal portion 60 in the X-axis direction may be set to 100 to 400. The length W2 of the terminal portion 60 in the X-axis direction may be the same as the length W1 of the mesh portion 61. The length L1 of the terminal portion 60 in the Y-axis direction may be set to 300 to 2000 μm. The length L1 of the terminal portion 60 in the Y-axis direction may be greater than the length W2 of the terminal portion 60 in the X-axis direction.

In the planar conductor portion 62, the length Py in the Y-axis direction may be greater than or equal to the length Px in the X-axis direction. That is, the length Py of the planar conductor portion 62 in the Y-axis direction may be greater than or equal to the length Px thereof in the X-axis direction. In the present embodiment, the planar conductor portion 62 has a rectangular shape whose longitudinal direction is the Y-axis direction. The length Py of the planar conductor portion 62 in the Y-axis direction may be greater than a separation distance between the planar conductor portion 62 and the terminal portion 60. Here, the separation distance between the planar conductor portion 62 and the terminal portion 60 is equal to the length y, in the Y-axis direction, of the first region 63 of the mesh portion 61. The length Py of the planar conductor portion 62 in the Y-axis direction may be less than twice the length Px thereof in the X-axis direction. Specifically, the length Px may be 100 to 400 μm, and the length Py may be 400 to 600 μm.

Here, the image display unit 10 is included which functions as a ground electrode disposed on the other main surface side of the light transmissive substrate 1 (see FIG. 4). The distance between the planar conductor portion 62 and the image display unit 10 serving as the ground electrode may be less than the length Py of the planar conductor portion 62 in the Y-axis direction.

The length Px of the planar conductor portion 62 in the X-axis direction may be equal to the length W1 of the mesh portion 61 in the X-axis direction. However, the length Px of the planar conductor portion 62 in the X-axis direction may be smaller or larger than the length W1 of the mesh portion 61 in the X-axis direction.

The length y of the first region 63 of the mesh portion 61 in the Y-axis direction may be less than or equal to the pitch of the mesh portion 61. The length y of the first region 63 of the mesh portion 61 in the Y-axis direction may be shorter than the length L1 of the terminal portion 22 in the Y-axis direction, the length Py of the planar conductor portion 62 in the Y-axis direction, and the length W1 of the mesh portion 61 in the X-axis direction. Specifically, the length y may be 100 to 200 μm.

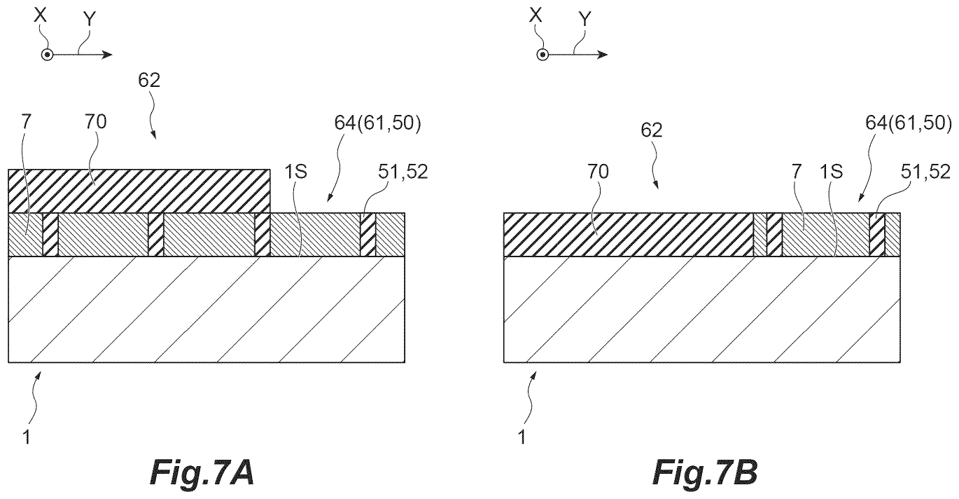

A layer structure of the planar conductor portion 62 is described with reference to FIGS. 7A and 7B. As illustrated in FIG. 7A, the planar conductor portion 62 may be configured by placing a conductor layer 70 on the mesh-like conductor pattern 50. Specifically, the planar conductor portion 62 is so configured that the conductor layer 70 covers the upper surfaces of the electroconductive lines 51 and 52 of the mesh-like conductor pattern 50 and the upper surface of an insulating layer 7. In this case, the planar conductor portion 62 may be thicker than the mesh portion 61. Alternatively, as illustrated in FIG. 7B, the planar conductor portion 62 may be configured by embedding the conductor layer 70 in the mesh-like conductor pattern 50. Specifically, the planar conductor portion 62 is configured by placing the conductor layer 70, instead of the mesh-like conductor pattern 50, on the main surface 1S of the light transmissive substrate 1. In this case, the mesh portion 61 and the planar conductor portion 62 have the same thickness. In FIG. 7B, the mesh portion 61 and the planar conductor portion 62 are connected in the Y-axis direction, and the mesh portion 61 and the planar conductor portion 62 are placed side by side in the same plane.

Next, functions and effects of the transmission line 210, the antenna 200, and the display device 100 according to the present embodiment will be described.

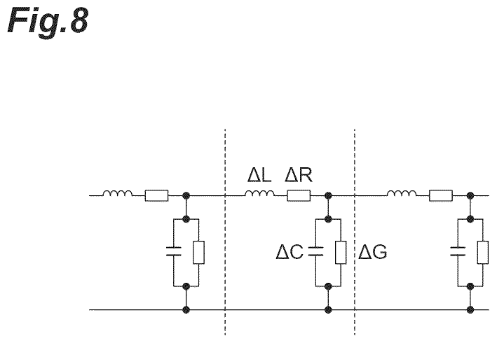

First, the characteristic impedance of the transmission line will be described. An equivalent circuit of the transmission line is illustrated in FIG. 8. The characteristic impedance is given by Formula (1). Further, R₀ is given by Formula (2), and X₀ is given by Formula (3). Note that L represents inductance, R represents resistance, C represents capacitance, and G represents conductance. Each of the values indicates a value per unit length of the line.

$$\begin{matrix}[ Math . 1 ] & \\ {Z}_{0} = \sqrt{\frac{R + j ω L}{G + j ω C}} ≡ {R}_{0} + {jX}_{0} & ( 1 )\end{matrix}$$

$${R}_{0} = \sqrt{\frac{1}{2} ( \sqrt{\frac{{R}^{2} + {ω}^{2} {L}^{2}}{{G}^{2} + {ω}^{2} {C}^{2}}} + \frac{RG + {ω}^{2} LC}{{G}^{2} + {ω}^{2} {C}^{2}} )} \qquad ( 2 )$$

$${X}_{0} = \pm \sqrt{\frac{1}{2} ( \sqrt{\frac{{R}^{2} + {ω}^{2} {L}^{2}}{{G}^{2} + {ω}^{2} {C}^{2}}} - \frac{RG + {ω}^{2} LC}{{G}^{2} + {ω}^{2} {C}^{2}} )} \qquad ( 3 )$$

In a case where a low-loss transmission line in which the entire line portion is a planar conductor portion, rather than the line portion configured with a mesh-like conductor, is employed (referred to as a non-mesh type), R₀ is approximated as shown in Formula (4), and X₀ is approximated as shown in Formula (5). On the other hand, in a case where the line portion is configured with a mesh-like conductor pattern (referred to as a mesh type), the inductance L increases and the capacitance C decreases, so that R₀ increases and X₀ is not 0. As a result, in the mesh type, the characteristic impedance increases and the frequency dependence increases as compared with the non-mesh type.

$$\begin{matrix}[ Math . 2 ] & \\ {R}_{0} \approx \sqrt{\frac{R}{G}} \approx \sqrt{\frac{L}{C}} & ( 4 )\end{matrix}$$

$${X}_{0} \approx 0 \qquad ( 5 )$$

In contrast, according to the transmission line 210 of the present embodiment, the line portion 25 includes the mesh portion 61 configured with the electroconductive lines. Therefore, the inductance of the line portion 25 increases. On the other hand, the line portion 25 has the planar conductor portion 62 that is electrically connected to the mesh portion 61 and has the conductor extending so as to form a planar surface. The planar conductor portion 62 is disposed apart from the terminal portion 60 in the Y-axis direction, and the planar conductor portion 62 has a length in the Y-axis direction greater than or equal to a length thereof in the X-axis direction orthogonal to the Y-axis direction. According to such a configuration, the planar conductor portion 62 can function as a capacitance component that cancels the increase in inductance in the mesh portion 61. Thereby, even in a structure in which the line portion 25 has the mesh portion 61, the return loss can be reduced over a wide frequency range.

The planar conductor portion 62 may have a rectangular shape whose longitudinal direction is the Y-axis direction. In this case, it is possible to sufficiently secure the capacitance of the planar conductor portion 62.

The mesh portion 61 may have the first region 63 disposed between the terminal portion 60 and the planar conductor portion 62, and the second region 64 sandwiching the planar conductor portion 62 with the first region 63. In this case, the return loss can be reduced over a wide frequency range.

The conductor pattern including an opening may be a mesh-like conductor pattern. In this case, high transparency can be achieved while conductivity is exhibited.

The length of the first region 63 in the Y-axis direction may be less than or equal to the mesh pitch of the mesh portion 61. In this case, it is possible to prevent the return loss from increasing.

The mesh portion 61 and the planar conductor portion 62 may be connected in the Y-axis direction. In this case, the return loss can be reduced over a wide band.

The length of the planar conductor portion 62 in the X-axis direction may be equal to the length of the mesh portion 61 in the X-axis direction. In this case, the return loss can be reduced over a wide band.

The length of the planar conductor portion 62 in the Y-axis direction may be greater than the separation distance between the planar conductor portion 62 and the terminal portion 60. In this case, it is possible to sufficiently secure the capacitance of the planar conductor portion 62.

The length of the planar conductor portion 62 in the Y-axis direction may be less than twice the length thereof in the X-axis direction. In this case, the planar conductor portion 62 can sufficiently secure a capacitance component that cancels the increase in inductance in the mesh portion 61 and reduce the return loss over a wide band.

The antenna 200 according to the present embodiment includes the transmission line 210, and the radiating element portion 24 connected to the transmission line 210.

According to the antenna 200, functions and effects similar to those of the transmission line 210 can be achieved.

The display device 100 according to the present embodiment includes the antenna 200.

According to the display device 100, functions and effects similar to those of the transmission line 210 can be achieved.

The display device 100 includes the image display unit 10 as the ground electrode disposed on the other main surface side of the dielectric, and the distance between the planar conductor portion 62 and the ground electrode may be less than the length of the planar conductor portion 62 in the Y-axis direction. In this case, a capacitance component suitable for canceling the increase in inductance in the mesh portion 61 can be generated, and the return loss can be reduced over a wide band.

The present disclosure is not limited to the above-described embodiment.

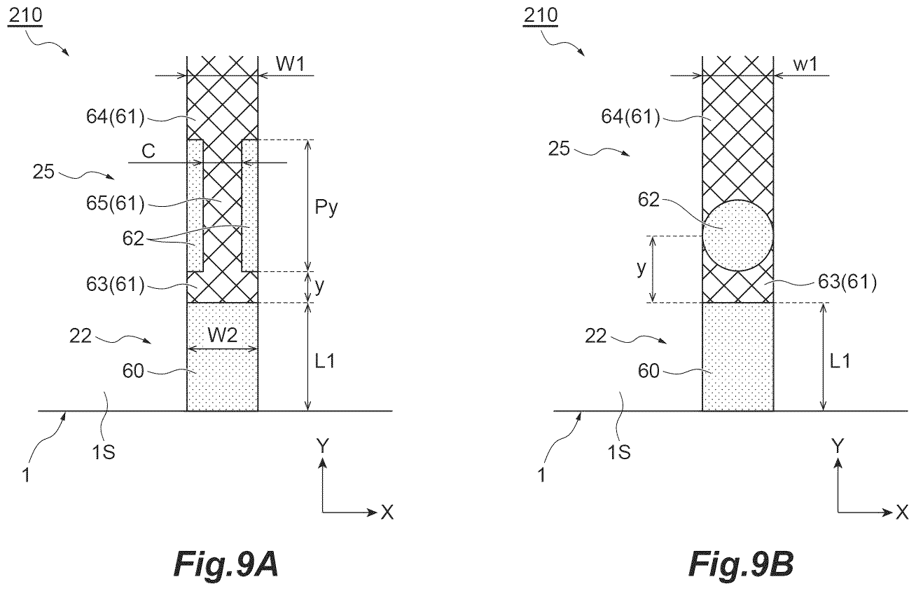

For example, the shape of the planar conductor portion 62 is not limited to the above-described embodiment. For example, as illustrated in FIG. 9A, a pair of planar conductor portions 62 divided so as to be separated from each other in the X-axis direction may be employed. A third region 65 of the mesh portion 61 is provided between the pair of planar conductor portions 62. Alternatively, as illustrated in FIG. 9B, a circular planar conductor portion 62 may be employed. The planar conductor portion 62 illustrated in FIG. 9B has a shape of a perfect circle, and therefore, the length of the planar conductor portion 62 in the Y-axis direction is equal to the length thereof in the X-axis direction. Note that the planar conductor portion 62 may have an elliptical or oval shape whose longitudinal direction is the Y-axis direction.

For example, the configuration illustrated in FIG. 5 is merely an example of the configuration of the antenna, and the shapes of the individual constituent elements may be appropriately changed.

Further, the pattern of the conductor pattern may be appropriately changed without departing from the gist of the present disclosure.

In the embodiment, the mesh portion is exemplified as the opening conductor portion having a conductor pattern including an opening. However, the opening conductor portion is not limited to the mesh portion, and a conductor pattern including a honeycomb-shaped opening or a conductor pattern including a dot-shaped opening may be adopted.

FIG. 1 is merely an example of the overall configuration of the electroconductive film, and the electroconductive layer may be formed in any range and shape in the electroconductive film.

Although the display device has been exemplified as the device to which the electroconductive film is applied, the electroconductive film may be applied to other devices. For example, the electroconductive film may be applied to glass or the like of a building, an automobile, or the like.

In the embodiment described above, the transmission line used as an antenna has been exemplified; however, the application of the structure of the transmission line is not limited, and the transmission line may be applied to, for example, a touch sensor.

### EXAMPLES

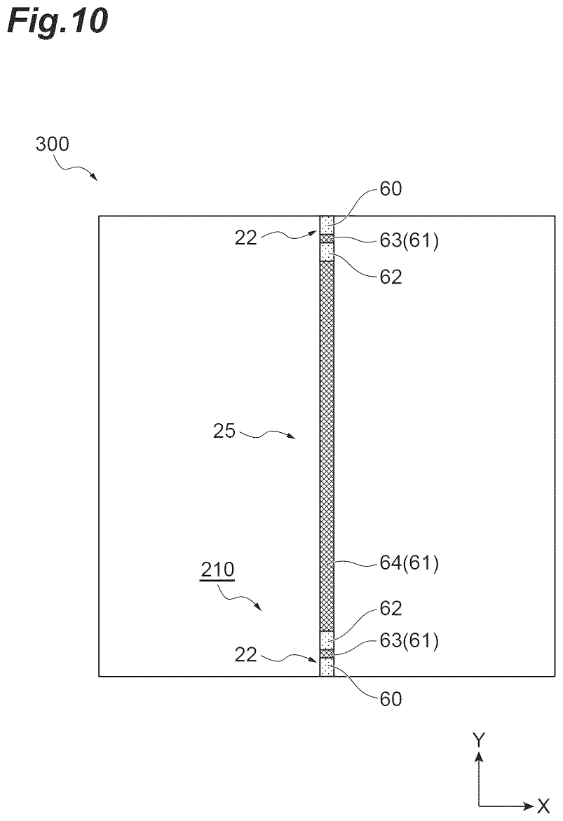

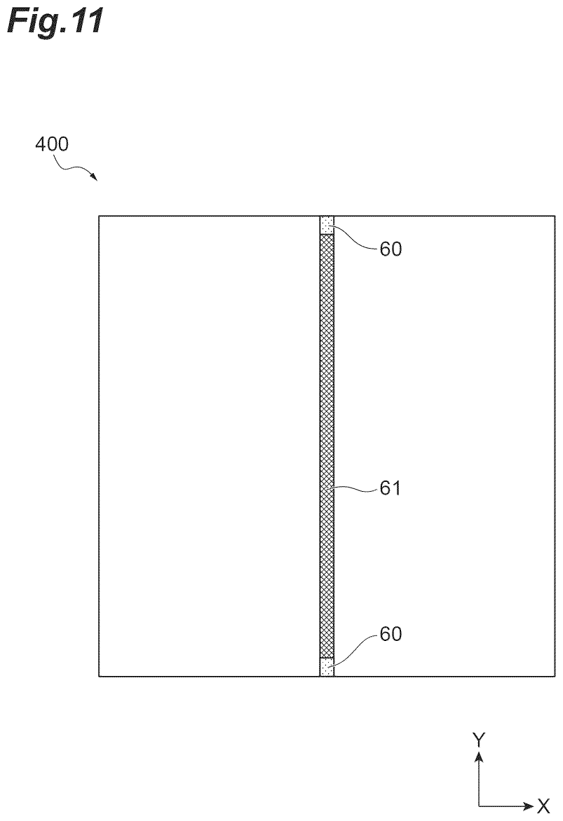

In order to measure the characteristics of the transmission line 210, a test specimen 300 according to an example as illustrated in FIG. 10 was prepared. The test specimen 300 illustrated in FIG. 10 has the structure of the transmission line 210 having the configuration illustrated in FIG. 6 at both ends of the test specimen 300. Note that the lengths W1, W2, and Px are each 270 μm, the length Py is 500 μm, the length y is 100 μm, and the length L1 is 500 μm (see FIG. 6). The total length of the transmission line 210 is 10 mm, the width of the mesh electroconductive line is 2 μm, and the mesh pitch is 100 μm. The light transmissive substrate 1 as the dielectric has a relative dielectric constant of 2.4 and a thickness of 100 μm. For comparison, a test specimen 400 according to a comparative example as illustrated in FIG. 11 was prepared. The test specimen 400 illustrated in FIG. 11 does not have the planar conductor portion 62. Other dimensions and so on are the same as those in the example.

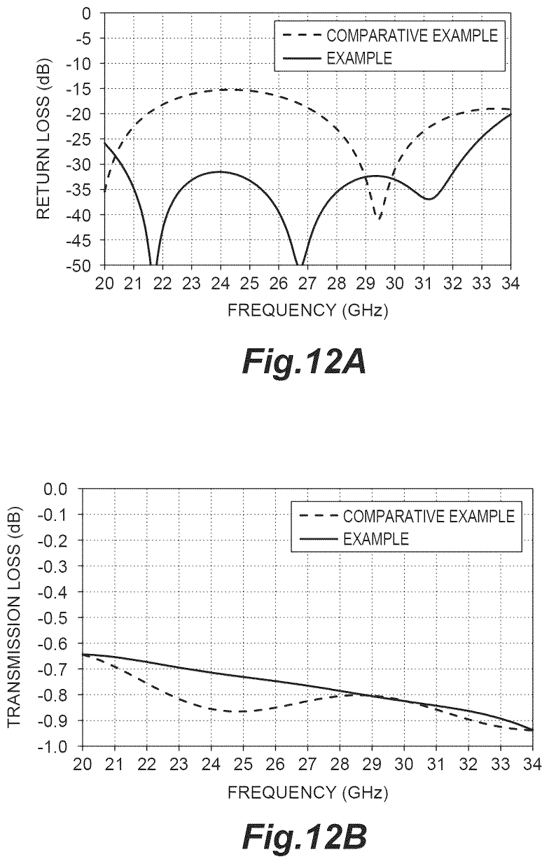

FIGS. 12A and 12B show measurement results of the example and the comparative example. As illustrated in FIG. 12A, in the comparative example, the return loss decreases only at a specific frequency, which indicates that reducing the return loss over a wide band is difficult. In contrast, it is indicated that, in the example, the frequency band in which the return loss is decreased is widened as compared with the comparative example. Regarding the transmission loss, FIG. 12B shows that the transmission loss does not increase in the example as compared with the comparative example.

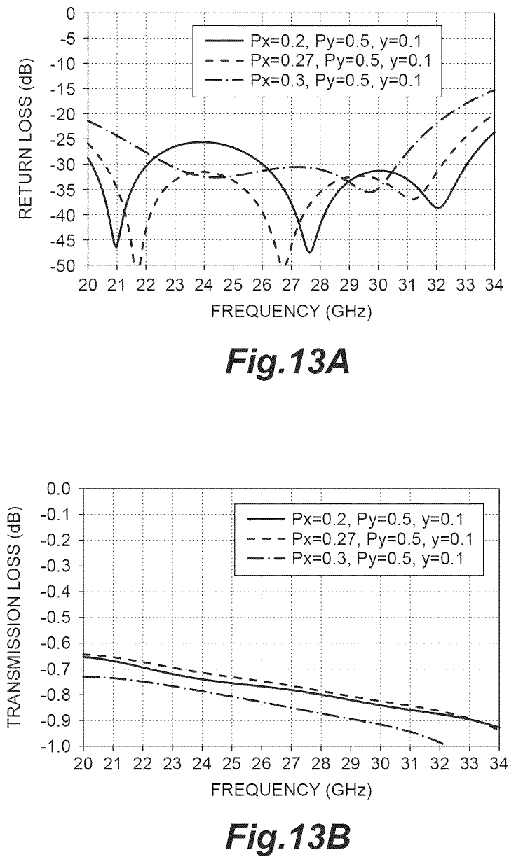

Next, as to the test specimen 300 illustrated in FIG. 10, simulation results obtained by adjusting the dimensions, shapes, and the like of each part are described. FIGS. 13A and 13B show simulation results for cases where the length Px of the planar conductor portion 62 in the X-axis direction is 200 μm, 270μ, and 300 μm. The simulation results of FIGS. 13A and 13B show that, in any case, the return loss can be reduced over a wide band as compared with the comparative example in FIGS. 12A and 12B. The simulation results of FIGS. 13A and 13B show that the return loss can be reduced over a wider band when the length Px is equal to 270 μm, which is the length W1 of the mesh portion 61. The simulation results of FIG. 13B show that, in any case, the transmission loss has a value close to 0 as compared with the comparative example in FIGS. 12A and 12B, which enables achieving good transmission characteristics. The simulation results of FIG. 13B show that better transmission characteristics can be achieved when the length Px is equal to 270 μm, which is the length W1 of the mesh portion 61.

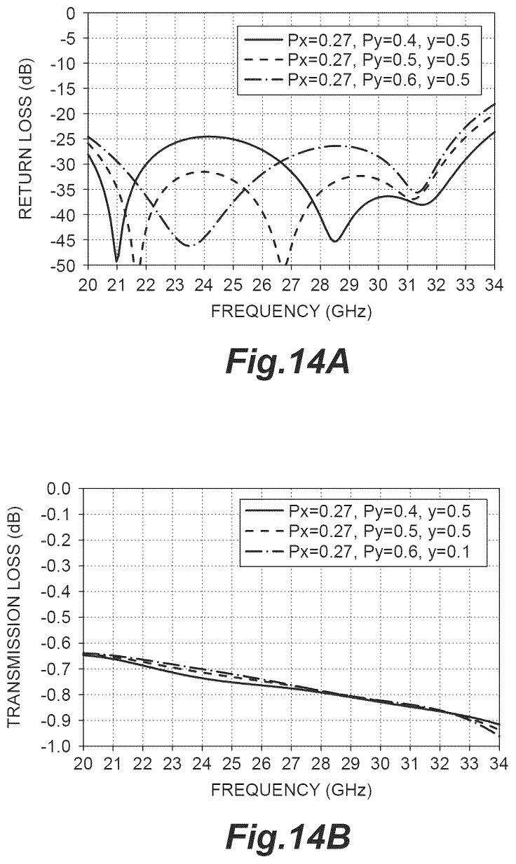

FIGS. 14A and 14B show simulation results for cases where the length Py of the planar conductor portion 62 in the y-axis direction is 400 μm, 500 μm, and 600 μm. The simulation results of FIGS. 14A and 14B show that, in any case, the return loss can be reduced over a wide band as compared with the comparative example in FIGS. 12A and 12B. In addition, the simulation results of FIGS. 14A and 14B show that the return loss can be reduced over a wide band by increasing the length Py. The simulation results of FIG. 14A show that the return loss can be reduced over a wider band in a case where the length Py is 500 μm, which is less than twice the length Px. The simulation results of FIG. 14B show that, in any case, the transmission loss has a value close to 0 as compared with the comparative example in FIGS. 12A and 12B, which enables achieving good transmission characteristics.

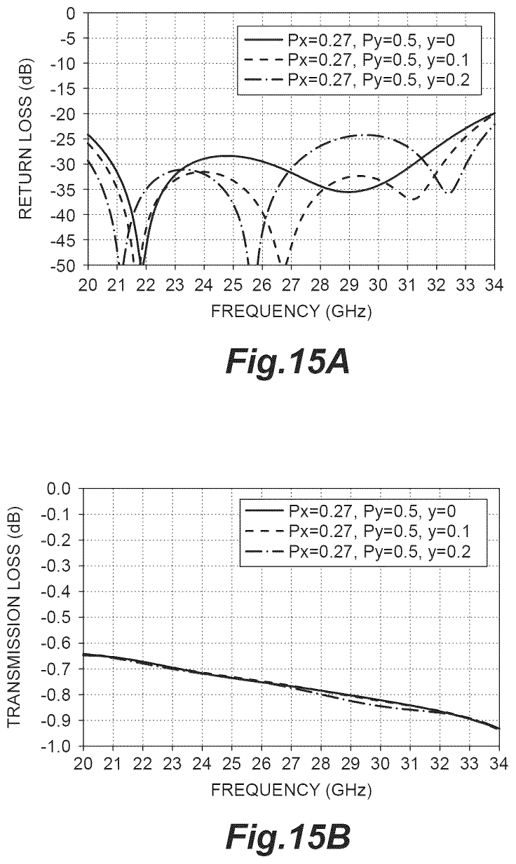

FIGS. 15A and 15B show simulation results for cases where the length y of the first region 63 in the Y-axis direction is 0 μm, 0.1 μm, and 0.2 μm. The simulation results of FIGS. 15A and 15B show that, in any case, the return loss can be reduced over a wide band as compared with the comparative example in FIGS. 12A and 12B. In addition, the simulation results of FIGS. 15A and 15B show that the return loss can be reduced over a wide band in a case where the length y along which the planar conductor portion 62 is disposed apart from the terminal portion 60 is 0.1 μm and 0.2 μm. The simulation results of FIGS. 15A and 15B show that the return loss can be reduced over a wider band in a case where the length y is 0.1 μm which is less than the mesh pitch. The simulation results of FIG. 15B show that, in any case, the transmission loss has a value close to 0 as compared with the comparative example in FIGS. 12A and 12B, which enables achieving good transmission characteristics.

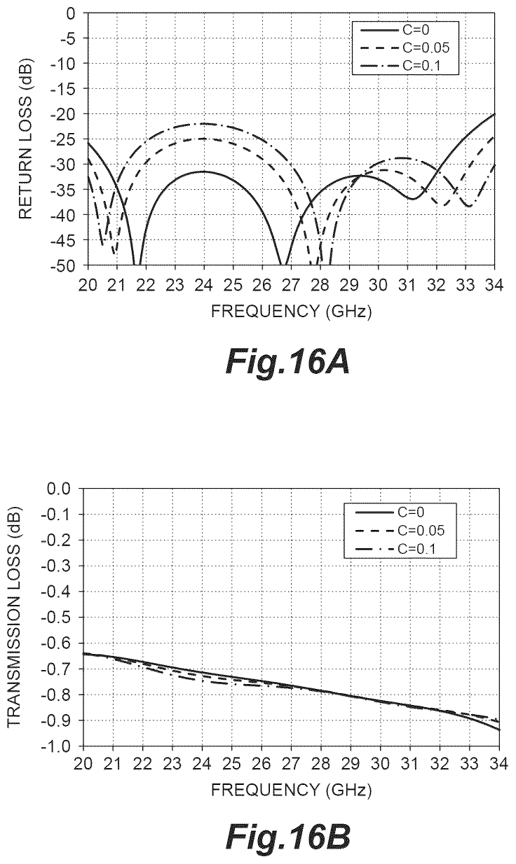

FIGS. 16A and 16B show simulation results of a configuration in which the planar conductor portion 62 is divided as illustrated in FIG. 9A. FIGS. 16A and 16B shows simulation results for cases where a separation distance C between the pair of planar conductor portions 62 in the X-axis direction is 0 μm, 50 μm, and 100 μm. The simulation results of FIGS. 16A and 16B show that the return loss can be reduced over a wider band in a case where the planar conductor portion 62 is not divided (case where the separation distance C is 0 μm). On the other hand, the simulation results of FIGS. 16A and 16B show that, even in a case where the planar conductor portion 62 is divided (case where the separation distance C is 50 μm or 100 μm), the return loss can be reduced over a wide band as compared with the comparative example in FIGS. 12A and 12B, and the transmission loss is slightly different from that for a case where the separation distance C is 0 μm. This shows that a transmission line sufficiently exhibiting the performance can be achieved even in a case where the planar conductor portion 62 is divided. The simulation results of FIG. 16B show that, in any case, the transmission loss has a value close to 0 as compared with the comparative example in FIGS. 12A and 12B, which enables achieving good transmission characteristics.

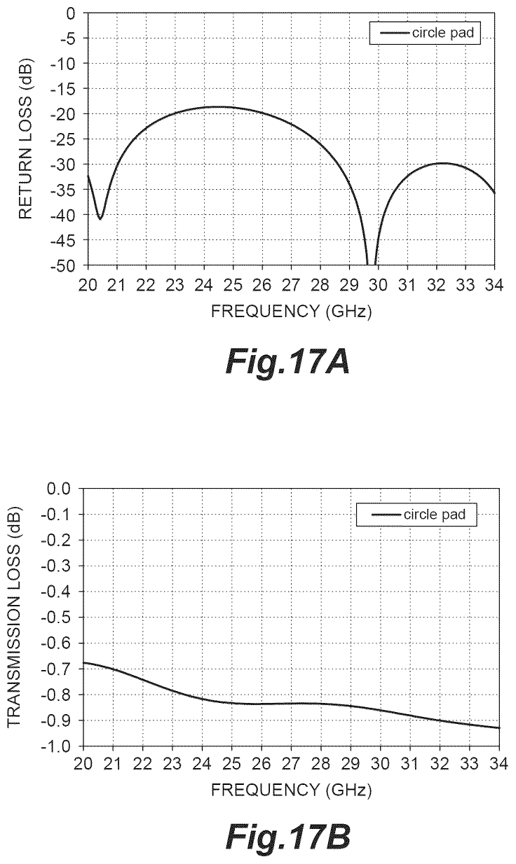

FIGS. 17A and 17B show simulation results of a configuration in which the planar conductor portion 62 having a circular shape is employed as illustrated in FIG. 9B. A simulation result is shown for a case where the diameter of the planar conductor portion 62 is 270 μm and the length y thereof is 300 μm. The measurement result of FIGS. 17A and 17B show that, even in the case of the planar conductor portion 62 having a circular shape, the return loss can be reduced over a wide band as compared with the comparative example in FIGS. 12A and 12B and a transmission line sufficiently exhibiting the performance can be achieved. The simulation result of FIG. 17B shows that the transmission loss has a value close to 0 as compared with the comparative example in FIGS. 12A and 12B, which enables achieving good transmission characteristics.

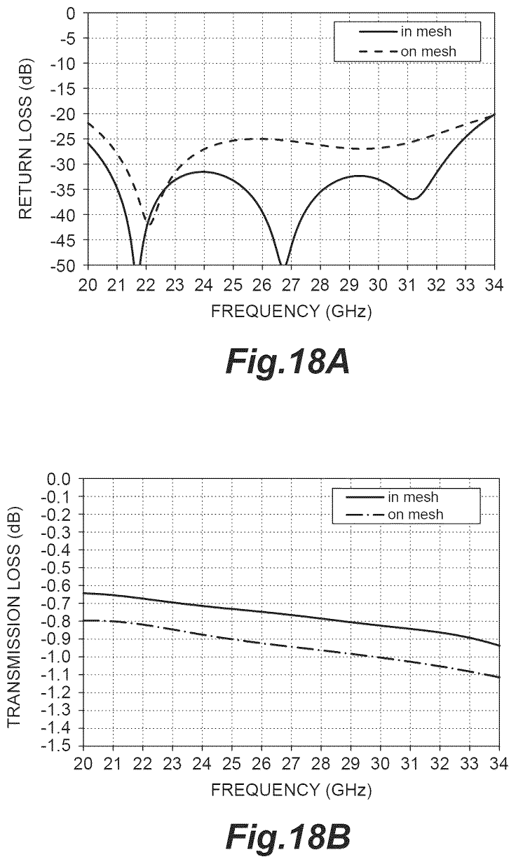

FIGS. 18A and 18B show simulation results for a case where the planar conductor portion 62 is configured by placing the conductor layer 70 on the mesh-like conductor pattern 50 (on mesh) as illustrated in FIG. 7A and for a case where the planar conductor portion 62 is configured by embedding the conductor layer 70 in the mesh-like conductor pattern 50 (in mesh) as illustrated in FIG. 7B. The simulation results of FIGS. 18A and 18B show that the return loss can be reduced over a wide band in the case of in-mesh, and that the return loss can be reduced over a wide band also in the case of on-mesh as compared with the comparative example in FIGS. 12A and 12B. The simulation results of FIGS. 18A and 18B show that a transmission line sufficiently exhibiting the performance can be achieved in both in-mesh and on-mesh cases. The simulation results of FIG. 18B show that, in any case, the transmission loss has a value close to 0 as compared with the comparative example in FIGS. 12A and 12B, which enables achieving good transmission characteristics. The simulation results of FIG. 18B show that better transmission characteristics can be achieved in the case of in-mesh.

The technique according to the present disclosure includes the following configuration examples, yet is not limited thereto.

A transmission line according to one aspect of the present disclosure includes a line portion extending in a first direction on one main surface side of a dielectric, and a terminal portion connected to an end part of the line portion, in which the line portion includes an opening conductor portion having a conductor pattern including an opening, and a planar conductor portion configured to be electrically connected to the opening conductor portion and to have a conductor extending so as to form a planar surface, the planar conductor portion is disposed apart from the terminal portion in the first direction, and the planar conductor portion has a length in the first direction greater than or equal to a length of the planar conductor portion in a second direction orthogonal to the first direction.

According to the transmission line, the line portion includes the opening conductor portion configured with the electroconductive lines. Therefore, the inductance of the line portion increases. On the other hand, the line portion has the planar conductor portion that is electrically connected to the opening conductor portion and has the conductor extending so as to form a planar surface. The planar conductor portion is disposed apart from the terminal portion in the first direction, and the planar conductor portion has a length in the first direction greater than or equal to a length thereof in the second direction orthogonal to the first direction. According to such a configuration, the planar conductor portion can function as a capacitance component that cancels the increase in inductance in the opening conductor portion. Thereby, even in a structure in which the line portion has the opening conductor portion, the return loss can be reduced over a wide frequency range.

The planar conductor portion may have a rectangular shape whose longitudinal direction is the first direction. In this case, it is possible to sufficiently secure the capacitance of the planar conductor portion.

The opening conductor portion may have the first region disposed between the terminal portion and the planar conductor portion, and the second region sandwiching the planar conductor portion with the first region. In this case, the return loss can be reduced over a wide frequency range.

The conductor pattern including an opening may be a mesh-like conductor pattern. In this case, high transparency can be achieved while conductivity is exhibited.

The length of the first region in the first direction may be less than or equal to the mesh pitch of the opening conductor portion. In this case, it is possible to prevent the return loss from increasing.

The opening conductor portion and the planar conductor portion may be connected in the first direction. In this case, the return loss can be reduced over a wide band.

The length of the planar conductor portion in the second direction may be equal to the length of the opening conductor portion in the second direction. In this case, the return loss can be reduced over a wide band.

The length of the planar conductor portion in the first direction may be greater than the separation distance between the planar conductor portion and the terminal portion. In this case, it is possible to sufficiently secure the capacitance of the planar conductor portion.

The length of the planar conductor portion in the first direction may be less than twice the length thereof in the second direction. In this case, the planar conductor portion can sufficiently secure a capacitance component that cancels the increase in inductance in the opening conductor portion and reduce the return loss over a wide band.

An antenna according to an aspect of the present disclosure includes the transmission line and a radiating element portion connected to the transmission line.

According to the antenna, functions and effects similar to those of the transmission line can be achieved.

A display device according to an aspect of the present disclosure includes the antenna described above.

According to the display device, functions and effects similar to those of the transmission line can be achieved.

The display device includes a display unit disposed on the other main surface side of the dielectric, and the distance between the planar conductor portion and the display unit may be less than the length of the planar conductor portion in the first direction. In this case, it is possible to achieve an effect of reducing the return loss over a wide band as the transmission line while the light transparency of the display surface in the display device is maintained.

### Embodiment 1

A transmission line including:
a line portion extending in a first direction on one main surface side of a dielectric; and
a terminal portion connected to an end part of the line portion, in which the line portion includes:
   an opening conductor portion having a conductor pattern including an opening; and
   a planar conductor portion configured to be electrically connected to the opening conductor portion and to have a conductor extending so as to form a planar surface,
the planar conductor portion is disposed apart from the terminal portion in the first direction, and
the planar conductor portion has a length in the first direction greater than or equal to a length of the planar conductor portion in a second direction orthogonal to the first direction.

### Embodiment 2

The transmission line according to embodiment 1, in which the planar conductor portion has a rectangular shape whose longitudinal direction is the first direction.

### Embodiment 3

The transmission line according to embodiment 1 or 2, in which the opening conductor portion includes
a first region disposed between the terminal portion and the planar conductor portion, and
a second region sandwiching the planar conductor portion with the first region.

### Embodiment 4

The transmission line according to embodiment 3, in which the conductor pattern including the opening is a mesh-like conductor pattern.

### Embodiment 5

The transmission line according to embodiment 4, in which a length of the first region in the first direction is less than or equal to a mesh pitch of the opening conductor portion.

### Embodiment 6

The transmission line according to any one of embodiments 1 to 5, in which the opening conductor portion and the planar conductor portion are connected in the first direction.

### Embodiment 7

The transmission line according to any one of embodiments 1 to 6, in which the length of the planar conductor portion in the second direction is equal to a length of the opening conductor portion in the second direction.

### Embodiment 8

The transmission line according to any one of embodiments 1 to 7, in which the length of the planar conductor portion in the first direction is greater than a separation distance between the planar conductor portion and the terminal portion.

### Embodiment 9

The transmission line according to any one of embodiments 1 to 8, in which the length of the planar conductor portion in the first direction is less than twice the length of the planar conductor portion in the second direction.

### Embodiment 10

An antenna including: the transmission line according to any one of embodiments 1 to 9; and a radiating element portion connected to the transmission line.

### Embodiment 11

A display device including the antenna according to embodiment 10.

### Embodiment 12

The display device according to embodiment 11, including a display unit disposed on another main surface side of the dielectric, in which
a distance between the planar conductor portion and the display unit is less than the length of the planar conductor portion in the first direction.

### REFERENCE SIGNS LIST

1 Light transmissive substrate (dielectric)
24 Radiating element portion
25 Line portion
60 Terminal portion
61 Mesh portion (opening conductor portion)
62 Planar conductor portion
63 First region
64 Second region
100 Display device
200 Antenna
210 Transmission line

What is claimed is:

1. A transmission line comprising:
a line portion extending in a first direction on one main surface side of a dielectric; and
a terminal portion connected to an end part of the line portion, wherein
the line portion includes:
an opening conductor portion having a conductor pattern including an opening; and
a planar conductor portion configured to be electrically connected to the opening conductor portion and to have a conductor extending so as to form a planar surface,
the planar conductor portion is disposed apart from the terminal portion in the first direction, and
the planar conductor portion has a length in the first direction greater than or equal to a length of the planar conductor portion in a second direction orthogonal to the first direction.

2. The transmission line according to claim 1, wherein the planar conductor portion has a rectangular shape whose longitudinal direction is the first direction.

3. The transmission line according to claim 1, wherein the opening conductor portion includes
a first region disposed between the terminal portion and the planar conductor portion, and
a second region sandwiching the planar conductor portion with the first region.

4. The transmission line according to claim 3, wherein the conductor pattern including the opening is a mesh-like conductor pattern.

5. The transmission line according to claim 4, wherein a length of the first region in the first direction is less than or equal to a mesh pitch of the opening conductor portion.

6. The transmission line according to claim 1, wherein the opening conductor portion and the planar conductor portion are connected in the first direction.

7. The transmission line according to claim 1, wherein the length of the planar conductor portion in the second direction is equal to a length of the opening conductor portion in the second direction.

8. The transmission line according to claim 1, wherein the length of the planar conductor portion in the first direction is greater than a separation distance between the planar conductor portion and the terminal portion.

9. The transmission line according to claim 1, wherein the length of the planar conductor portion in the first direction is less than twice the length of the planar conductor portion in the second direction.

10. An antenna comprising: the transmission line according to claim 1; and a radiating element portion connected to the transmission line.

11. A display device comprising the antenna according to claim 10.

12. The display device according to claim 11, comprising a display unit disposed on another main surface side of the dielectric, wherein
a distance between the planar conductor portion and the display unit is less than the length of the planar conductor portion in the first direction.
